(19) United States
(12) Patent Application Publication
(10) Pub. No.: US 2006/0249953 A1
(43) Pub. Date: Nov. 9, 2006

(54) Quick connector for rimmed vessel

(75) Inventors: James H. Gill, Woodbury, GA (US); James S. Smith, Jackson, GA (US); Robert S. Matthews, Williamson, GA (US); Ronald L. Diehl, Milner, GA (US)

Correspondence Address: IP GROUP OF DLA PIPER RUDNICK GRAY CARY US LLP, 1650 MARKET ST, SUITE 4900, PHILADELPHIA, PA, 19103, US

(73) Assignee: B&G Equipment Company, a Delaware corporation, Jackson, GA (US)

(21) Appl. No.: 11/121,365

(22) Filed: May 4, 2005

(51) Int. Cl. F16L 21/06

(52) U.S. Cl. 285/324

(57) ABSTRACT

A quick connector is adapted to be attached to a fluid-containing vessel, such as an aerosol can. The quick connector includes a body having a passage through which fluid can flow when the quick connector is attached to the vessel. The quick connector preferably includes an attachment mechanism in the form of a plurality of radially flexible legs angularly disposed around a longitudinal axis of the passage and extending proximally from the body. An inwardly disposed finger is disposed at the proximal end of each of the legs. The locking ring travels between a first position in which the legs are free to flex outwardly and a second position in which the legs flex inwardly such that the fingers engage the vessel rim when the quick connector is attached to the vessel. Some embodiments include a floating capitulator to accommodate vessels having fluid delivery stems of varying sizes.

### FIELD OF THE INVENTION

The invention relates to the field of fluid delivery from a fluid-containing vessel. The invention is particularly well suited for attaching one or more useful elements to a rimmed vessel having a fluid delivery stem, such as an aerosol can.

### BACKGROUND

Vessels for delivering fluids are well known. Examples of these vessels are aerosol cans, which commonly include a desired product suspended or dissolved in a liquefied or pressurized gas called the propellant. As used herein, the term “fluid” should be understood to include colloidal systems, such as solid or liquid particles suspended or otherwise dispersed in a gas, solids dispersed or dissolved in a liquid, as well as pure or mixed liquids and gasses.

A rim is often provided around the top of an aerosol can to accommodate a protective cap. Commonly, the cap is removable to reveal a fluid delivery stem protruding upwardly from the top of the can. When pressed downwardly by a user, the stem opens a valve and initiates fluid flow from the can. Conveniently, a nozzle may be attached to the top of the stem to provide a pressing surface for the user and to direct the spray of fluid away from the user, in the case of pesticides, paints or other fluids that are not recommended for human contact, or toward the user, in the case of deodorants or other fluids intended to be sprayed on the user.

It is sometimes necessary to spray the contents of an aerosol can or other vessel onto surfaces or into areas that are difficult to reach because of the size of the can itself and the unyielding connection between it and the spray nozzle. Therefore, it is desirable to deliver the spray remotely from the can. A known device for establishing spray remotely from the can includes a flexible hose and a remote spray assembly. The hose is attached to the aerosol can through an attachment assembly that includes a compression fitting, a user actuated valve, an adapter and a can clamp. The can clamp includes a first surface for engaging a portion of the rim of the can, and a cam surface that can be rotated into engagement with another portion of the rim to lock the assembly onto the can.

What is needed is a mechanism by which useful elements, such as a flexible hose and remote spray assembly, can be more easily and conveniently connected to a fluid-containing vessel.

### SUMMARY OF THE INVENTION

This invention relates to a quick connector that is adapted to be attached to a rimmed vessel, such as an aerosol can. The quick connector includes a body having a passage through which fluid can flow when the quick connector is attached to the vessel and an attachment mechanism for attaching the quick connector to the vessel. A preferred attachment mechanism includes a plurality of radially flexible legs angularly disposed around a longitudinal axis of the passage and extending proximally from the body. An inwardly disposed finger is disposed at the proximal end of each of the legs. The fingers are sized and shaped to engage the rim of the vessel. A longitudinally traveling locking ring is provided in association with the legs. The locking ring travels between a first position in which the legs are free to flex outwardly and a second position in which the legs flex inwardly such that the fingers engage the vessel rim when the quick connector is attached to the vessel.

The invention also relates to a quick connector that can be adapted for use with aerosol cans or other types of vessels having fluid delivery stems of variable length. According to these embodiments, the quick connector includes a floating capitulator in combination with a body having a fluid flow passage and an attachment mechanism for attaching the quick connector to the vessel. The floating capitulator is adapted to ride longitudinally within the body, and includes a proximal end with a stem receiving surface adapted to receive the fluid delivery stem and to establish fluid communication with the vessel. The floating capitulator further includes a distal end with a connector adapted to receive a flexible hose or other element that can advantageously be attached to the vessel. Further, the quick connector can include a biasing member that urges the floating capitulator proximally with respect to the body to ensure fluid communication with the stem of the vessel regardless of the length of the stem.

### BRIEF DESCRIPTION OF THE DRAWINGS

For the purpose of illustrating the invention, there are shown in the drawings forms which are presently preferred; it being understood, that this invention is not limited to the precise arrangements and instrumentalities shown.

FIG. 1 is an isometric view of a quick connector according to a first exemplary embodiment of the invention in combination with a flexible hose and remote spray assembly. The quick connector is shown with a locking ring in the first position.

FIG. 2 is an isometric view of the quick connector according to the first exemplary embodiment of the invention in combination with the flexible hose and remote spray assembly. The quick connector is shown with the locking ring in the second position.

FIG. 3 is an exploded view of the quick connector according to the first exemplary embodiment in combination with the flexible hose and remote spray assembly.

FIG. 4 is a cross sectional view of the quick connector of the first exemplary embodiment in combination with the top of an aerosol can. The quick connector is shown with the locking ring in the first position.

FIG. 5 is a cross sectional view of the quick connector of the first exemplary embodiment in combination with the top of the aerosol can. The quick connector is shown with the locking ring in the second position.

FIG. 6 is a cross sectional view of a quick connector according to a second exemplary embodiment of the invention in combination with the top of the aerosol can. The quick connector is shown with the locking ring in the first position.

FIG. 7 is a cross sectional view of the quick connector of the second exemplary embodiment in combination with the top of the aerosol can. The quick connector is shown with the locking ring in the second position.

### DETAILED DESCRIPTION

It will be appreciated that the following description is intended to refer to exemplary embodiments of the invention selected for illustration in the drawings and is not intended to define or limit the invention, other than in the appended claim.

For the purpose of describing the invention, certain directional terms are used herein. These terms are intended to describe direction or relative location of the various elements of the invention with reference to the environment in which the quick connectors is intended to be used, i.e., when attached to a vessel. However, these terms retain their meaning when the quick connector is not attached to the vessel. For example, the phrase “movement toward the vessel when the quick connector is attached thereto” carries the same meaning as “movement toward the surface of the quick connector that would be closest to the vessel if the quick connector were attached thereto”. Thus, the terms should not be construed as limiting the invention to any particular orientation in space or to the time when the quick connector is actually attached to the vessel.

As used herein, the terms “longitudinal” and “longitudinally” refer to an axis coincidental with the vertical axis of the vessel when the quick connector is attached thereto, such as the axis of the stem of an aerosol can, or to a direction that is parallel with the vertical axis of the vessel. These terms can also refer to the relative position of elements with respect to such a direction.

As used herein, the terms “proximal” and “proximally” refer to a longitudinal direction toward the vessel when the quick connector is attached thereto. These terms also refer to a relative longitudinal position near to the vessel. These terms may be equated with the terms “downward” or “downwardly” when the quick connector is oriented with the vessel-receiving end down.

As used herein, the terms “distal” and “distally” refer to a longitudinal direction away from the vessel when the quick connector is attached thereto. These terms also refer to a relative longitudinal position away from the vessel. These terms may be equated with the terms “upward” or “upwardly” when the quick connector is oriented with the vessel-receiving end down.

The terms “radial” and “radially” refer to relative position or movement in directions extending transversely from a longitudinal axis.

The terms “inward” and “inwardly” refer to relative radial position or movement toward the center of the quick connector.

The terms “outward” and “outwardly” refer to relative radial position or movement away from the center of the quick connector.

It should be understood that a directional term does not imply exclusivity. Thus, longitudinal (proximal or distal) movement or relative position can also have a radial (inward or outward) component unless otherwise indicated.

The term “radial plane” refers to a plane that extends in radial directions, in which no point is significantly proximal or distal to any other.

The term “angularly disposed” refers to two or more elements that are positioned around a reference element in approximately the same radial plane. Such angularly disposed elements are typically, but not necessarily, equidistant from the reference element, and are typically, but not necessarily, spaced apart by equal angles.

In the figures, in which like reference numerals indicate like elements, there are shown preferred embodiments of a quick connector adapted to be attached to a rimmed vessel, such as an aerosol can.

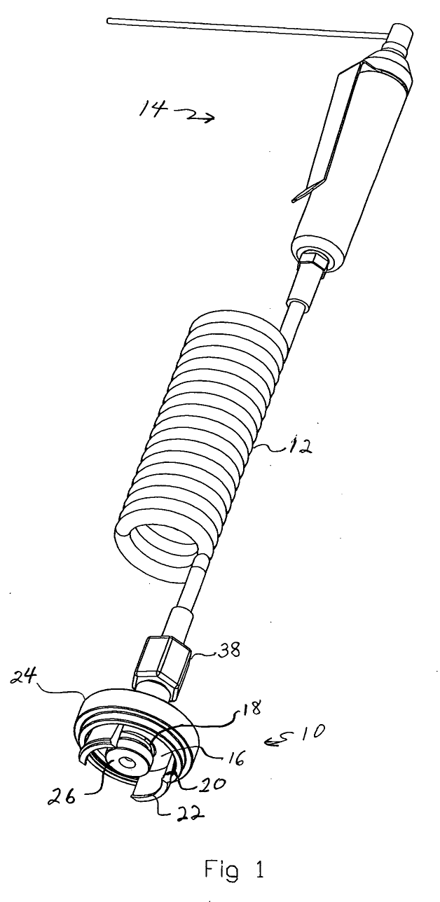

FIGS. 1-3 show a first embodiment of a quick connector 10 in association with a flexible hose 12 and a remote spray assembly 14 attached to the distal end of the hose 12. The quick connector 10 is preferably used in association with such a hose and spray assemble, but can instead be used with other elements that can advantageously be attached to a rimmed vessel. For example, it may be desirable to attach an elongated rigid tube that extends distally, transversely or both. Another example of a useful element could be a transfer pipe for attaching two vessels to charge one from the other. As explained below, the distal end of the quick connector 10 may be modified to accommodate such other useful elements as needed.

The quick connector 10 can include a body 16 having a fluid flow passage 18 through which fluid can flow when the quick connector 10 is attached to the vessel. A plurality of radially flexible legs 20 are angularly disposed around a longitudinal axis of the passage 18 and extend proximally from the body 16. Two legs 20 are shown in the drawings. However, any number of angularly disposed legs may be provided in practicing the invention. The flexible legs 20 are preferably formed such that the proximal ends of the legs 20 tend to project slightly outwardly when free of external influence. The legs 20 are preferably formed of unitary construction with the body 16, such as by injection molding using acetal resin. An inwardly disposed finger 22 is provided at the proximal end of each of the legs 20. Each of the fingers 22 are sized and shaped to engage the rim of the vessel.

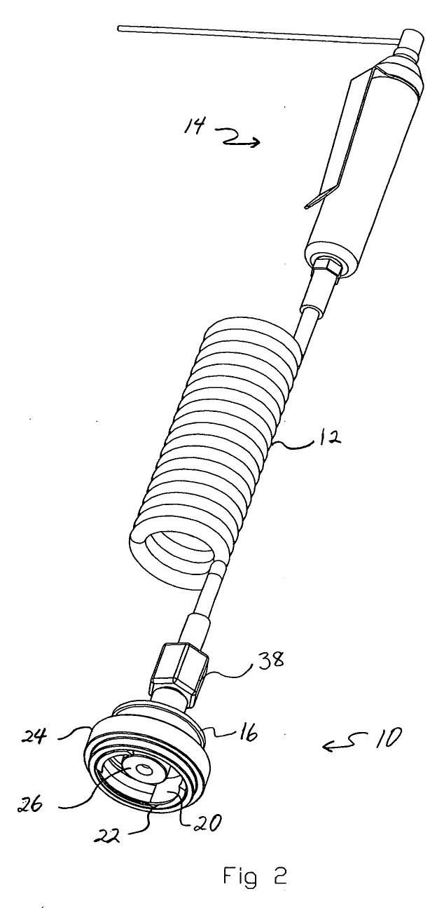

A traveling locking ring 24, formed for example from PVC, can be provided in association with the legs 20. The locking ring 24 travels longitudinally between a first position, shown in FIG. 1, in which the legs 20 are free to flex outwardly and a second position, shown in FIG. 2, in which the locking ring 24 urges the legs 20 to flex inwardly such that the fingers engage the vessel rim when the quick connector is attached to the vessel. The locking ring can travel proximally to move from the first position to the second position, and distally to return to the first position. The inward flexation of the legs 20 leaves open the possibility, but does not require, that the proximal ends of the legs 20 be inward relative to the distal end of the legs 20. Rather, the inward flexation when the locking ring 24 is in the second position means that the proximal ends are inward relative to their own position when the locking ring 24 is in the first position. Preferably, the flexible legs 20 are resiliently flexible and biased to flex outwardly when the traveling locking ring 24 is in the second position so as to exert outward force on the locking ring to impede distal movement of the traveling locking ring by friction.

Preferably, the locking ring 24 surrounds the body 16 and/or legs 20. Thus, where the body 16 has a circular transverse cross section and the legs are arcuate, the locking ring 24 is preferably circular as shown. However, the locking ring, body and/or legs can also be in polygonal shapes that approximate a circle, such as triangular, square, hexagonal octagonal, etc., so long as the locking ring 24 provides adequate contact with the legs 20 to urge them inwardly to engage the vessel rim when in the second position.

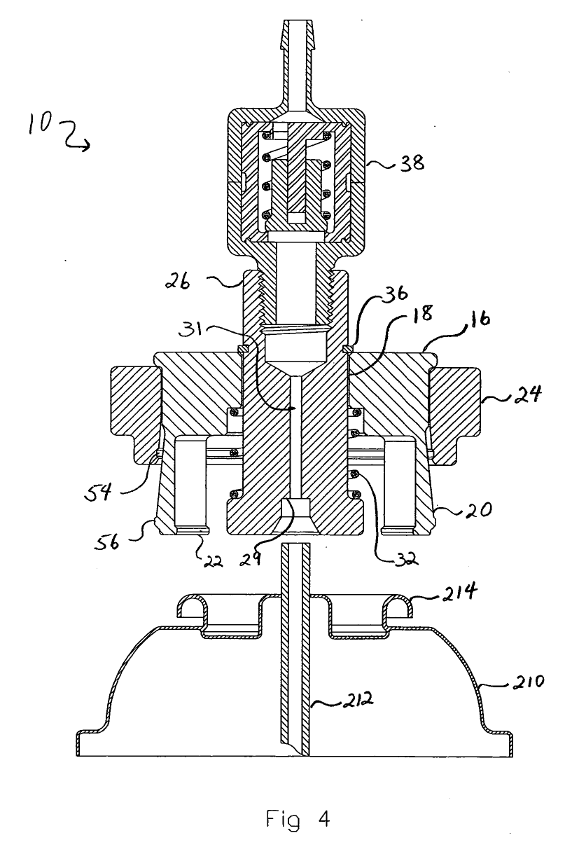

The quick connector 10 can include a floating capitulator 26 adapted to ride longitudinally within the body. The floating capitulator 26 can be formed from acetal resin or other material compatible with the fluid housed in the vessel. The floating capitulator 26 has a proximal end 28 adapted for fluid communication with the vessel when the quick connector is engaged therewith, and a distal end 30. The floating capitulator 26 is particularly advantageous if the quick connector 10 is to be attached to an aerosol can because aerosol cans may have upwardly protruding stems of variable length. The floating capitulator 26 allows the quick connector to be attached to any such can (with limits on stem length that are dictated by the travel path of the floating capitulator 26), while automatically adjusting for the stem length of the particular can. The proximal end 28 of the floating capitulator can be provided with a recessed stem receiving surface 29 (FIG. 4) for receiving the stem of the aerosol can.

The floating capitulator 26 can ride longitudinally within the fluid passage 18 of the body 16 and includes its own fluid passage 31 (FIG. 4) through which fluid can flow when the quick connector 10 is attached to the vessel. The quick connector 10 can include a biasing member that urges the floating capitulator 26 proximally. The biasing member can be in the form of a coil spring 32 formed, for example, from music wire. The coil spring 32 can be retained around the floating capitulator 26 between the body 16 and a flange 34 disposed on the proximal end of the floating capitulator 26. A retaining member is preferably provided to limit proximal movement of the floating capitulator 26. The retaining member may be provided in the form of a retaining ring 36 engaged with an annular groove in the floating capitulator 26 distal to the body 16. The retaining ring 36 can prevent the biasing member from urging the floating capitulator too far proximally and prevent disassociation between the floating capitulator 26 and the fluid passage 18.

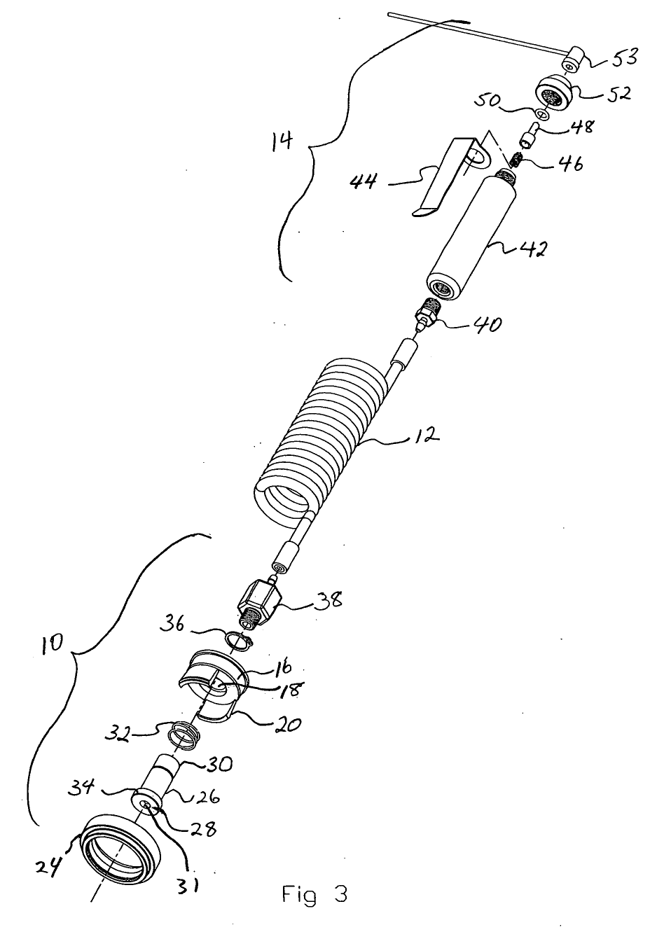

The quick connector 10 can also include a check valve assembly 38 attached to the distal end of the floating capitulator 26. For this purpose, the distal end of the floating capitulator can be provided with female threads and the check valve provided with male threads, or vice versa. Other types of connections are also possible. The check valve assembly 38 can be adapted to permit fluid flow from the vessel in the distal direction when the quick connector 10 is attached thereto. Thus, once attached to the vessel, the hose 12 can become pressurized or “charged” with fluid. The check valve assembly 38 can prevent fluid flow from the charged hose 12 in the proximal direction if the quick connector 10 is removed from the vessel. A suitable check valve assembly is commercially available from Microchek of Lodi, Calif. under the trade name “Microchek Valve”. Such a valve includes a spring-biased poppet that is guided by an internal rail, and can include a variety of connectors, including barbs (as shown in FIGS. 3-5) and male or female threads, any of which are available in different sizes.

As noted above, FIGS. 1-3 show the quick connector in association with the hose 12 and remote spray assembly 14. When the quick connector 10 is to be so used, the distal end of the check valve assembly 38 can be provided with a hose barb for engaging the hose 12. The hose 12 can be formed from polyester or other suitable flexible material that can be selected according to desired physical and chemical properties, such as those relating to compatibility with the fluid housed in the vessel.

The remote spray assembly 14 can include a hose connector 40, which may be formed from, for example, nylon, having a hose barb for engaging the distal end of the hose 12. The distal end of the hose connector can be threadedly engaged with a handle 42. The distal end of the handle can be outfitted with a pocket clip 44 and an actuator mechanism. The actuator mechanism can be of the type assembled from an actuator tip spring 46, an actuator tip 48, an actuator seal 50 and a handle cap 52. Such an actuator mechanism is known in the art and will not be described further herein. Further, a transverse spray nozzle 53 can be engaged with the actuator tip so that a user can releasably actuate the spray tip and affect spray from the hose 12 remotely from the vessel when the quick connector 10, hose 12 and remote spray assembly 14 are attached to the vessel. In the instance that the vessel includes its own spray nozzle, that nozzle can be removed to expose the top of the stem to the stem receiving surface 29. Provided that the can stem and actuator tip 48 have similar outer diameters, the nozzle removed from the can may be used as the spray nozzle 53 by attaching the nozzle to the actuator tip 48, which projects through the handle cap 52.

If the quick connector 10 is to be connected to a useful element other than a flexible hose, the check valve assembly 38 can be provided with an alternative type of appropriate connector. Thus, the distal end of the check valve assembly 38 can be provided with a sealed connector selected according to the corresponding useful element to be attached to the vessel. Alternatively, an adapter can be supplied on the distal end of the check valve assembly to provide the appropriate connector, in which case the adapter can serve as the distal end of the quick connector 10. Such connectors can include hose barbs of various sizes, male or female threads, bayonet connectors, friction fits, lip/groove connections, cam fits, etc.

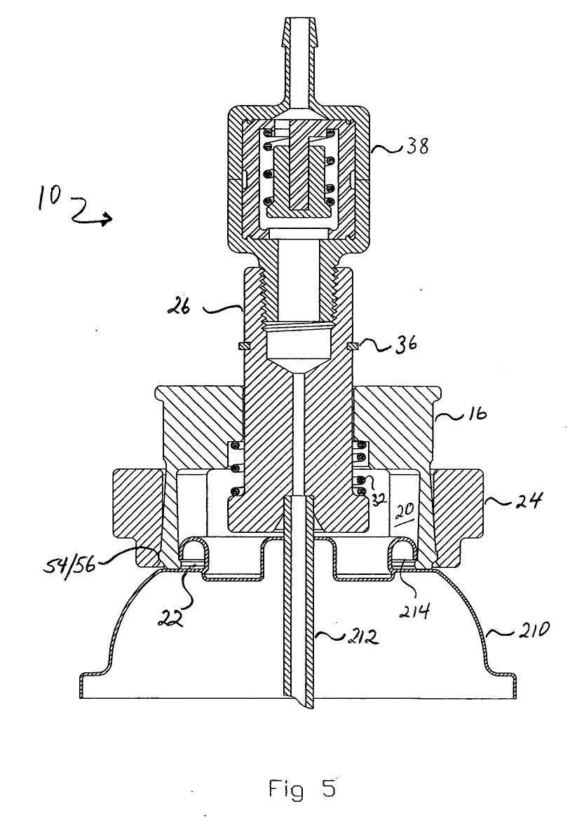

FIGS. 4 and 5 show a longitudinal cross section of the quick connector in association with a vessel. An exemplary vessel for use with the quick connector is an aerosol can 210 having a fluid delivery stem 212 and a rim 214. FIG. 4 shows the quick connector 12 prior to engagement with the aerosol can 210. It should be understood that the hatched portions of the drawings represent those portions through which the cross section cuts. The non-hatched surfaces immediately inside of the hatched portions of legs 20 and fingers 22 are the inside surfaces of the legs 20 and fingers 22, and are preferably curved surfaces that correspond with the curvature of the rim 214 of the can 210. As such, in FIG. 4, where the locking ring 24 is in the first position, a distance D1 between two paired reference points on the inside surfaces of legs 20 or fingers 22 is preferably the same as the distance D1 between any other set of paired reference points on the inside surfaces of legs 20 or fingers 22 as long as all of the reference points lie in a common radial plane and the reference points within each pair are disposed along a common line that extends through the radial center of the quick connector.

FIG. 5 shows the quick connector 10 engaged with the can 210 and the locking ring 24 in the second position. The configuration of FIG. 5 is preferably achieved when a user moves the locking ring 24 from the first position to the second position while the quick connector is being mounted on the can 210 and the fingers 22 are proximal to the rim 214. In this configuration, the legs 20 are flexed inwardly such that the fingers 22 engage the rim 214 of the can 210. When the locking ring 24 is in the second position, a distance D2 between two paired reference points on the inside surfaces of legs 20 or fingers 22 is preferably the same as the distance D2 between any other set of paired reference points on the inside surfaces of legs 20 or fingers 22 as long as all of the reference points lie in a common radial plane and the reference points within each pair are disposed along a common line that extends through the radial center of the quick connector. When the same reference points are used, the distance D2 is preferably less than the distance D1. Thus, if the legs 20 are resiliently flexible, the legs 20 exert outward force on the locking ring 24 in an effort to restore the distance D1. This force provides friction against the inside surface of the locking ring 24 and impedes distal movement of the locking ring 24. It is possible that the outward force exerted by the legs 20 can alone be adequate to retain the locking ring 24 in the second position.

To further enhance retention of the locking ring 24 in the second position, the inside surface of the locking ring 24 can be provided with a groove 54. The outside surface of the legs 20 can be provided with outwardly extending ribs 56 to engage the groove 54 when the locking ring 24 is in the second position. The combination of the outward force exerted by the legs 20 and fit between the corresponding groove 54 and ribs 56 tends to retain the locking ring 24 in the second position. However, it is possible that the legs 20 are not resiliently flexible, or that the legs are resiliently flexible with a resting position inward of that shown in FIG. 5 such that D1 is equal to or less than D2. In either of these cases, the corresponding groove 54 and ribs 56 can alone adequately retain the locking ring 24.

In FIG. 4, prior to engagement of the quick connector 10 and the can 210, the floating capitulator 26 is biased to the maximum proximal position (with respect to the body 16) that is permitted by retaining ring 36. In this configuration, the coil spring 32 is at or relatively near its neutral position.

In FIG. 5, where the quick connector 10 is engaged with the can 210 and the locking ring 24 is in the second position, it can be seen that the top of the can stem 212 is engaged with the stem receiving surface 29 of the floating capitulator 26 such that the top of the stem 212 and the stem receiving surface 29 provide distal and proximal forces, respectively, against one another. The coil spring 32 should provide sufficient resistance to compression so that adequate proximal force (downward force with respect to the can stem 212) is supplied to push the stem downwardly and initiate fluid flow from the can 210 into the quick connector 10. The distal force applied by the stem 212 to the stem receiving surface 29 urges the floating capitulator 26 distally against the tendency of the coil spring 32, thereby compressing and “loading” the coil spring 32. Thus, the coil spring provides a reactive proximal force to help form a seal between the stem receiving surface 29 and the stem 212. The ability of the floating capitulator to travel longitudinally in this fashion can allow a user to attach the quick connector 10 to different vessels of varying stem length.

However, it should be understood that the floating capitulator can be fixed to the body (i.e., non-floating and non-capitulating) if the quick connector is intended for use only on vessels of fixed stem length. In such an embodiment, the capitulator can be of unitary construction with the body, such as by integral molding, in which case the fluid low passage 18 of the body and the fluid flow passage 31 of the capitulator can be the same. Otherwise, the capitulator can be formed separately and then attached to the body, such as by glue, snapping or any other rigid attachment.

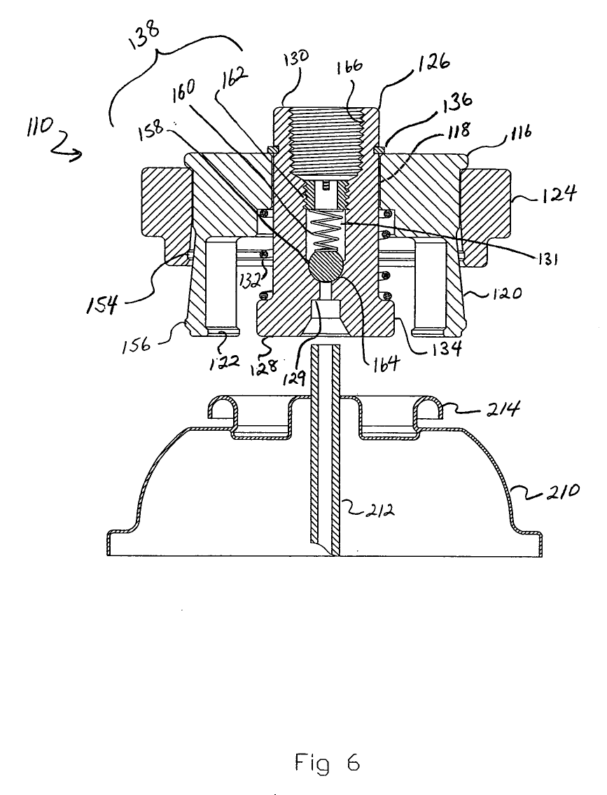

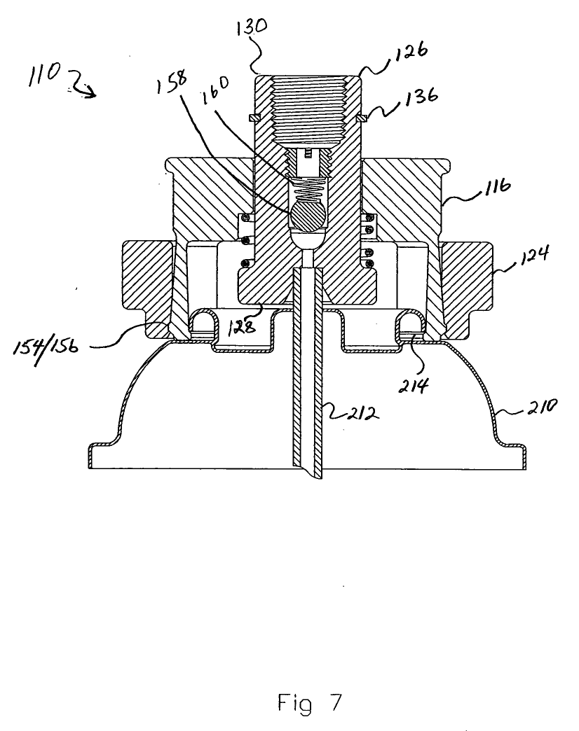

FIGS. 6 and 7 show longitudinal cross sections of an embodiment of the quick connector 110 in which a check valve 138 is provided within a floating capitulator 126. The quick connector 110 can include a body 116 having a fluid flow passage 118 through which fluid can flow when the quick connector 10 is attached to the vessel. The floating capitulator 126 is disposed within the fluid flow passage 118.

A plurality of radially flexible legs 120 are angularly disposed around a longitudinal axis of the passage 118 and extend proximally from the body 116. Any number of angularly disposed legs 120 may be provided in practicing the invention. The flexible legs 120 can be provided with inwardly disposed fingers 122, and otherwise can be formed and can function similarly to the legs 20 described above.

A traveling locking ring 124 can be provided in association with the legs 120. The locking ring 124 is analogous to the locking ring 24 and can be formed and can function similarly to the manner described above. The locking ring 124 travels longitudinally between a first position, shown in FIG. 6, in which the legs 120 are free to flex outwardly and a second position, shown in FIG. 7, in which the locking ring 124 urges the legs 120 to flex inwardly such that the fingers 122 engage the vessel rim 214 when the quick connector is attached to the vessel. The locking ring 124 can travel proximally to move from the first position to the second position, and distally to return to the first position. The inward flexation of the legs 120 does not require (but leaves open the possibility) that the proximal ends of the legs 120 be inward relative to the distal end of the legs 120. Rather, the inward flexation when the locking ring is in the second position means that the proximal ends are inward relative to their own position when the locking ring 124 is in the first position. Preferably, the flexible legs 120 are resiliently flexible and biased to flex outwardly when the locking ring 124 is in the second position so as to exert outward force on the locking ring 124 to impede distal movement of the traveling locking ring by friction.

Similar to the floating capitulator 26 described above, the floating capitulator 126 can ride longitudinally within the fluid passage 118 of the body 116. The floating capitulator 126 has a proximal end 128 adapted for fluid communication with the can 210 when the quick connector 110 is engaged therewith, and a distal end 130. The proximal end can include a recessed stem receiving surface 129. Like the floating capitulator 26, the floating capitulator 126 allows the quick connector to be attached to aerosol cans of varying stem length.

The floating capitulator 126 includes its own fluid passage 131 through which fluid can flow when the quick connector 110 is attached to the can 210. The quick connector 110 can include a biasing member that urges the floating capitulator 126 proximally. The biasing member can be in the form of a coil spring 132 retained around the floating capitulator 126 between the body 116 and a flange 134 disposed on the proximal end of the floating capitulator 126. A retaining member is preferably provided to limit proximal movement of the floating capitulator 126. The retaining member may be provided in the form of a retaining ring 136 engaged with an annular groove in the floating capitulator 126 distal to the body 116. The retaining ring 136 can prevent the biasing member from urging the floating capitulator too far proximally and can prevent disassociation between the floating capitulator 126 and the fluid passage 118.

The floating capitulator 126 has an internally disposed check valve assembly 138, including ball valve 158, biasing member 160 and spring stop 162. The ball valve 158 is biased against the valve seat 164 by the biasing member 160, which can be fixed in place by the spring stop 162 in threaded engagement with the inside surface of the floating capitulator 126. The distal inside surface of the floating capitulator 126 can be a connector, such as female threads 166, for attaching a flexible hose, such as through a male threaded hose barb (not shown). Alternatively, the distal end 130 of the floating capitulator 126 can be provided with another type of connector, such as those described above, to receive any other useful element that can advantageously be attached to a rimmed vessel.

When the quick connector 110 is engaged with the can 210, as in FIG. 7, the can stem 212 is pressed downwardly, initiating fluid flow from the can 210. The fluid flowing from the can 210 pushes the ball valve 158 distally against the tendency of the biasing member 160 and opens the fluid passage 131. If a hose or other fluid reservoir is attached to the distal end of the floating capitulator 126, it will become charged with fluid from the can 210. The check valve assembly 138 can prevent fluid flow from the charged reservoir in the proximal direction if the quick connector 110 is removed from the can 210 because, once removed, the ball valve 158 can move proximally under the influence of the biasing member 160 and form a seal against the valve seat 164.

As noted above, the flexible legs 122 function in a similar manner as the legs 22 of the embodiment shown in FIGS. 4 and 5. Thus, in FIG. 6, where the locking ring 124 is in the first position, a distance D3 between two paired reference points on the inside surfaces of legs 20 or fingers 22 is preferably the same as the distance D3 between any other set of paired reference points on the inside surfaces of legs 20 or fingers 22 as long as all of the reference points lie in a common radial plane and the reference points within each pair are disposed along a common line that extends through the radial center of the quick connector.

FIG. 7 shows the quick connector 110 engaged with the can 210 and the locking ring 124 in the second position. This configuration is preferably achieved when a user moves the locking ring 124 from the first position to the second position while the quick connector is being mounted on the can 210 and the fingers 122 are proximal to the rim 214. In this configuration, the legs 120 and fingers 122 are flexed inwardly to engage the rim 214 of the can 210. When the locking ring 124 is in the second position, a distance D4 between two paired reference points on the inside surfaces of legs 20 or fingers 22 is preferably the same as the distance D4 between any other set of paired reference points on the inside surfaces of legs 20 or fingers 22 as long as all of the reference points lie in a common radial plane and the reference points within each pair are disposed along a common line that extends through the radial center of the quick connector. When the same reference points are used, the distance D4 is preferably less than the distance D3. Thus, if the legs 120 are resiliently flexible, the legs 120 exert outward force on the locking ring 124 in an effort to restore the distance D3. This force can provide friction against the inside surface of the locking ring 124 and impedes distal movement of the locking ring 124. It is possible that the outward force exerted by the legs 120 can alone be adequate to retain the locking ring 124 in the second position.

To further enhance retention of the locking ring 124 in the second position, the inside surface of the locking ring 124 can be provided with a groove 154 and the outside surface of the legs 120 can be provided with outwardly extending ribs 156 to engage the groove 54 when the locking ring 124 is in the second position. The combination of the outward force exerted by the legs 120 and fit between the corresponding groove 154 and ribs 156 tends to retain the locking ring 124 in the second position in the same way as described above.

In FIG. 6, prior to engagement of the quick connector 110 and the can 210, the floating capitulator 126 is biased to the maximum proximal position (with respect to the body 116) that is permitted by a retaining member 136. In contrast, in FIG. 7, where the quick connector 110 is engaged with the can 210 and the locking ring 124 is in the second position, the top of the can stem 212 is engaged with the stem receiving surface 129 of the floating capitulator 126 such that the top of the stem 212 and the stem receiving surface 129 provide distal and proximal forces, respectively, against one another. The function of the coil spring 132, retaining member 136, stem receiving surface 129, can stem 212 and relative forces therebetween can all function in a similar manner as those described above with reference to FIGS. 4 and 5.

Also like the embodiment of FIGS. 4 and 5, it should be understood that the floating capitulator 126 can be fixed to the body (i.e., non-floating and non-capitulating) if the quick connector is intended for use only on vessels of fixed stem length.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

What is claimed is:

1. A quick connector adapted to be attached to a rimmed vessel, the quick connector comprising:
a body having a passage through which fluid can flow when the quick connector is attached to the vessel;
a plurality of radially flexible legs angularly disposed around a longitudinal axis of the passage and extending proximally from the body;
an inwardly disposed finger at the proximal end of each of the legs, the fingers being sized and shaped to engage the rim of the vessel;
a longitudinally traveling locking ring associated with the legs, the traveling locking ring having a first position in which the legs are free to flex outwardly and a second position in which the legs flex inwardly such that the fingers engage the vessel rim when the quick connector is attached to the vessel.

2. The quick connector of claim 1, wherein the fingers are shaped and sized to engage the rim of an aerosol can.

3. The quick connector of claim 1, further comprising a floating capitulator adapted to ride longitudinally within the body, the floating capitulator having a proximal end adapted for fluid communication with the vessel when the quick connector is engaged therewith, and a distal end.

4. The quick connector of claim 3, wherein the proximal end of the floating capitulator comprises a recessed stem receiving surface for receiving the stem of an aerosol can.

5. The quick connector of claim 3, further comprising a check valve attached to the distal end of the floating capitulator.

6. The quick connector of claim 3, further comprising a check valve disposed within the floating capitulator.

7. The quick connector of claim 3, further comprising a flexible hose in fluid communication with the distal end of the floating capitulator, and a user actuatable valve disposed on the hose distal from the floating capitulator.

8. The quick connector of claim 3, further comprising a biasing member that urges the floating capitulator proximally.

9. The quick connector of claim 8, further comprising a retaining member that limits the proximal movement of the floating capitulator.

10. The quick connector of claim 1, wherein, in use, the traveling locking ring travels proximally to move from the first position to the second position.

11. The quick connector of claim 10, wherein the plurality of radially flexible legs are biased to flex outwardly when the traveling locking ring is in the second position so as to exert outward force on the locking ring to impede distal movement of the traveling locking ring.

12. A quick connector adapted to be attached to an aerosol can or other vessel having a fluid delivery stem, the quick connector comprising:
a body having a fluid flow passage through which fluid can flow when the quick connector is attached to the vessel;
an attachment mechanism for attaching the quick connector to the vessel;
a floating capitulator adapted to ride longitudinally within the fluid flow passage of the body, the floating capitulator having a proximal end with a stem receiving surface adapted to receive the fluid delivery stem and establish fluid communication with the vessel, the floating capitulator further having a distal end with a connector adapted to receive a flexible hose or other element that can advantageously be attached to the vessel; and
a biasing member that urges the floating capitulator proximally with respect to the body.

13. The quick connector of claim 12 wherein the attachment mechanism comprises:
a plurality of radially flexible legs angularly disposed around a longitudinal axis of the fluid flow passage and extending proximally from the body;
an inwardly disposed finger at the proximal end of each of the legs, the fingers being sized and shaped to engage the rim of the vessel;
a longitudinally traveling locking ring associated with the legs, the traveling locking ring having a first position in which the legs are free to flex outwardly and a second position in which the legs flex inwardly such that the fingers engage the vessel rim when the quick connector is attached to the vessel.

14. The quick connector of claim 12, further comprising a check valve assembly attached to the connector at the distal end of the floating capitulator, the check valve assembly comprising a connector adapted to receive the flexible hose or other element that can advantageously be attached to the vessel.

15. The quick connector of claim 12, further comprising a check valve disposed within the floating capitulator.

16. The quick connector of claim 12, further comprising a flexible hose in fluid communication with the distal end of the floating capitulator, and a user actuatable valve disposed on the hose distal from the floating capitulator.

17. The quick connector of claim 12, further comprising a retaining member that limits the proximal movement of the floating capitulator.

18. A fluid delivery system comprising:
a quick connector comprising a longitudinally traveling locking ring;
a hose coupled to the quick connector; and,
a spray assembly coupled to the hose.

19. The fluid delivery system of claim 18 wherein the quick connector further comprises a floating capitulator.

20. A fluid delivery system comprising:
means for engaging the rim of a vessel;
means for locking the engaging means; and,
means for permitting fluid flow from the vessel to a hose connected to the vessel.

21. A quick connector comprising:
means for engaging the rim of a vessel; and,
means for locking the engaging means.
